(19) United States
(12) Patent Application Publication
(10) Pub. No.: US 2002/0030008 A1
(43) Pub. Date: Mar. 14, 2002

(54) Multi-component filter design

(75) Inventors: Michael S. Brunner, Roswell, GA (US); Robert J. Lyng, Alpharetta, GA (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 09/820,274

(22) Filed: Mar. 28, 2001

Related U.S. Application Data
(60) Provisional application No. 60/193,669, filed on Mar. 31, 2000.
(60) Provisional application No. 60/193,784, filed on Mar. 31, 2000.

(51) Int. Cl. B01D 29/00

(52) U.S. Cl. 210/483

(57) ABSTRACT

A multi-component liquid filter is provided having at least two filter elements. One of the filter elements has an increased effective surface area defined by, for example, a pleated surface, to provide an increased filtering surface area. In addition, another one of the filter elements can have a flat surface to minimize the filtering surface area of the element. In one embodiment, the multi-component liquid filter has at least two generally cylindrical filter elements arranged concentric relative to a common axis. One of the filter elements can have a circumferential filtering surface having an increased effective surface area and another one of the filter elements can have a constant radius circumferential filtering surface to minimize the filtering surface area of the element.

### RELATED APPLICATIONS

The present application claims the benefit of U.S. Provisional Application Nos. 60/193,669 and 60/193,784, both of which were filed on Mar. 31, 2000.

### BACKGROUND OF THE INVENTION

Fluid filtration devices have been developed for applications not requiring the scale or volume needed by municipal or industrial applications. Such devices range from those located at the point-of-use (e.g., the spigot of a kitchen sink, gravity-flow dispensers such as water pitchers, and low-pressure dispensers such as sports bottles) to the generally bulkier point-of-entry units hidden from view within the plumbing of a home or office.

Some devices have employed multiple filtering components or stages to accomplish effective filtration of various contaminants, such as particulates, organics, microorganisms, sediments, etc. Typically, multistage filtration devices contain two or more filter media components that are designed to remove different contaminants. For example, in some applications, it may be desired that the filter contain an initial stage for removing larger sized contaminants, such as sediments and other particulates. After removing the larger particles, it may then be desired to remove microorganisms within the water with another type of filter.

With conventional devices, each filter element normally has a surface area exposed to fluid flow therethrough equal to the largest surface area required by any one of the filter elements. In particular, most multi-stage filtration processes contain some type of filter chamber or housing in which the filter elements are disposed. As such, if one of the filter elements requires a large surface area, this requirement typically dictates that all other filter elements also possess the same relatively large surface area.

For example, when conventional filtering devices are arranged concentric relative to a common axis, and liquid flow through the filters is in a radial direction, the circumferential filtering surface area of each filter is determined by the radius of each filter. The filter element that is concentric within the other filter element will have less circumferential filtering surface area. However, limitation of the circumferential filtering surface area may result in a non-optimal configuration depending on the filter media. For example, certain filters are more efficient at filtering one type of contaminant with a greater surface area, whereas other filters are more efficient with a lesser surface area at filtering a different type of contaminant. The optimal filtering surface areas may be impossible to achieve by simply providing one filter in the form of a continuous radial cylinder within the other filter element.

As such, a need currently exists for an improved filtration device that utilizes at least two types of filter elements.

### SUMMARY OF THE INVENTION

The present invention provides a multi-component liquid filter that includes at least one filter element having a generally non-planar filtering surface with an irregular or regular pattern of surface contours, such as elevations or depressions, such that the effective surface area of the filter defined within the edges or boundary of the filter is increased over that of a generally flat filtering surface defined by an equal boundary or edges. For instance, one example of a suitable non-planar surface that can be utilized in the present invention is a pleated surface. By using a pleated surface, the filter element provides an increased effective surface contact area to a liquid flowing through the filter.

When utilized, pleats can be formed into a filter element according to a variety of methods. Moreover, depending on the particular application, the pleats can have a variety of sizes and formed into a variety of shapes. For instance, the pleats can have an average pitch (peak-to-peak distance) ranging from about 0.0625 to about 5 inches (about 1.587 mm to about 127 mm). In some embodiments, the average pitch of the pleats can range from about 0.125 to about 1 inch (about 3.175 mm to about 25.4 mm).

In accordance with the present invention, the multi-component filter can also contain at least one other filter element having a surface contact area less than the surface contact area of the generally non-planar filter element. Typically, it is desired that the generally non-planar filter element have a surface contact area at least about 10% greater than at least one other filter element. In some embodiments, the generally non-planar filter element can have a surface contact area between about 15% to about 600% or more greater than the surface contact area of at least one other filter element.

By providing such differential surface contact areas, it has been discovered that the filtration capabilities of each filter element may be optimized. For example, filters that are more efficient at filtering one type of contaminant with a greater surface area may be provided in the “non-planar” form, whereas other filters (or even the same type of filter) that are more efficient with a lesser surface area at filtering a different type of contaminant may be provided in a planar form.

The filter elements of the present invention can generally be made from a variety of materials or filter media. The particular material utilized for the filter element can allow each element to possess different filtration capabilities. For instance, depending on the filter media utilized, the filter element can be configured to remove various contaminants, such as turbidity-related components, microorganisms, sediments, organic materials, particulates, etc. For instance, in one embodiment of the present invention, the generally non-planar filter element can be made from a laminate material, while the generally planar filter element can be made from a charge modified material, such as microfiber glass.

In general, the filter elements of the present invention can also be arranged in a variety of ways. For instance, the filter elements can be provided in any order, shape, or configuration to achieve the desired results. In one embodiment of the present invention, for example, the multi-component liquid filter includes two filter elements, wherein a generally non-planar filter element is in fluid communication with a fluid inlet and a generally planar filter element is in fluid communication with a fluid outlet. The fluid flows from the inlet, through the filters, and out of the fluid outlet. In addition, any number of filter elements can be also used in the present invention.

For example, in one embodiment of the present invention, the filter device utilizes concentric filters wherein the circumferential filtering surface area of at least one of the filters is effectively increased by forming the filter as a generally cylindrical component having surface contours that substantially increase the circumferential filtering surface area. This filter may be the inner cylindrical filter, and may actually have an effective circumferential filtering surface area that is greater than the outer cylindrical filter element. In an alternative embodiment, the filter element with the surface contours may be the outer cylindrical filter and have a substantially increased circumferential filtering surface area.

In some embodiments, the filter device can include a chamber and first and second generally cylindrical filter elements disposed within the chamber with respect to a longitudinal centerline of the chamber. Either one of the first or second elements has inner and outer circumferential surfaces defined by a generally constant radius around the circumference thereof so as to provide a generally continuous planar circumferential filtering surface for liquid passing radially through the filter element. The other respective filter element has inner and outer circumferential surfaces defined by surface contours such that the circumferential surfaces have a non-constant radius therearound. In this manner, the circumferential surfaces with the surface contours define a generally discontinuous non-planar filtering surface having a greater effective filtering surface area compared to a continuous planar filtering surface for the liquid passing radially through the filter element. Liquid flows radially through the filter elements within the chamber such that different contaminants are removed by the respective filter elements prior to the liquid flowing from the chamber.

The concentric filter elements can be arranged so that the element having the continuous planar circumferential filtering surface is disposed concentric within the other filter element having the circumferential surface contours. In an alternative embodiment, the filter element having the surface contours is disposed concentric within the filter element having the continuous planar filtering surface. The arrangement of the filters will depend on the radial direction of flow of liquid through the filters, as well as the filtering media used in each of the filters. For example, the filter element having the surface contours, such as pleats, may be a large particulate matter filter, and it may be preferred to filter the liquid for such large particulate matters prior to the liquid passing through the other filter which may be made of a material for removing microorganisms, bacteria, or the like, from the liquid.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth in the specification, which makes reference to the appended drawings, in which:

FIG. 1 is an exploded view of one embodiment of a multi-component filter of the present invention;

FIG. 2 is a partial cut-away view of one embodiment of a multi-component filter of the present invention;

FIG. 3 is a partial cut-away view of another embodiment of a multi-component filter of the present invention;

FIG. 4 is a partial cut-away perspective view of one embodiment of the multi-component filter of the present invention; and

FIG. 5 is a perspective view of another embodiment of the multi-component filter according to the present invention.

Repeat use of reference characters in the present specification and drawings is intended to represent the same or analogous features or elements of the invention.

### DETAILED DESCRIPTION OF THE REPRESENTATIVE EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents.

### Definitions

As used herein, the phrase “non-planar” surface refers to any surface that has an increased effective surface area exposed to fluid flow defined within edges or a boundary of the filter, the increased surface area being due to at least some surface contour, such as an elevation or depression, formed in the surface.

As used herein, the phrase “planar surface” refers to an essentially flat surface void of surface contours, such that the surface area of the filter exposed to fluid flow therethrough is decreased as compared to a non-planar surface within an equal size boundary.

As used herein, the term “charge-modified material” means any material that has an electric charge upon at least some of its surfaces. The charge may be cationic or anionic, and of any magnitude.

As used herein, the term “nonwoven web” means a web or fabric having a structure of individual fibers or threads which are interlaid, but not in an identifiable manner as in a knitted or woven fabric. Any fibrous material can generally be used when forming a nonwoven web. For instance, examples of suitable materials can include polypropylene, nylon, polyester, etc. Moreover, nonwoven webs can generally be prepared by any of a variety of methods well known to those having ordinary skill in the art. Examples of such processes include, by way of illustration only, meltblowing, coforming, spunbonding, carding and bonding, air laying, and wet laying. Meltblowing, coforming, and spunbonding processes are exemplified by the following references, each of which is incorporated herein in its entirety by reference thereto for all purposes:

(a) Meltblowing references include, by way of example, U.S. Pat. Nos. 3,016,599 to Perry, Jr., 3,704,198 to Prentice, 3,755,527 to Keller et al., 3,849,241 to Butin et al., 3,978,185 to Butin et al., and 4,663,220 to Wisneski et al. See, also, V. A. Wente, “Superfine Thermo-plastic Fibers”, Industrial and Engineering Chemistry, Vol. 48, No. 8, pp. 1342-1346 (1956); V. A. Wente et al., “Manufacture of Superfine Organic Fibers”, Navy Research Laboratory, Washington, D.C., NRL Report 4364 (111437), dated May 25, 1954, United States Department of Commerce, Office of Technical Services; and Robert R. Butin and Dwight T. Lohkamp, “Melt Blowing—A One-Step Web Process for New Nonwoven Products”, Journal of the Technical Association of the Pulp and Paper Industry, Vol. 56, No.4, pp. 74-77 (1973);

(b) Coforming references, among others, include U.S. Pat. Nos. 4,100,324 to Anderson et al. and 4,118,531 to Hauser; and

(c) Spunbonding references include, among others, U.S. Pat. Nos. 3,341,394 to Kinney, 3,655,862 to Dorschner et al., 3,692,618 to Dorschner et al., 3,705,068 to Dobo et al., 3,802,817 to Matsuki et al., 3,853,651 to Porte, 4,064,605 to Akiyama et al., 4,091,140 to Harmon, 4,100,319 to Schwartz, 4,340,563 to Appel, 4,405,297 to Appel, 4,434,204 to Hartman et al., 4,627,811 to Greiser, and 4,644,045 to Fowells.

As used herein, a “nonwoven charge-modified microfiber glass web” can be a web that incorporates glass fibers having a charged coating thereon (e.g., cationically charged coating). In some instances, such microfibers can include glass fibers with a diameter of about 10 microns or less. In some instances, the coating includes a functionalized cationic polymer that has been thermally crosslinked; in other words, the functionalized cationic polymer has been thermally crosslinked after being coated onto the glass fibers. Such a fibrous filter is prepared by a method which involves providing a fibrous filter which includes glass fibers, passing a solution of a functionalized cationic polymer crosslinkable by heat through the fibrous filter under conditions sufficient to substantially coat the fibers with the functionalized cationic polymer, and treating the resulting coated fibrous filter with heat at a temperature and for a time sufficient to crosslink the functionalized cationic polymer present on the glass fibers. For example, the functionalized cationic polymer may be an epichlorohydrin-functionalized polyamine or an epichlorohydrin-functionalized polyamido-amine.

As used herein, the terms “cationically charged” and “cationic” refer to the presence of a plurality of positively charged groups. Thus, the terms “cationically charged” and “positively charged” are synonymous. Such positively charged groups can, for example, include a plurality of quaternary ammonium groups, but they are not necessarily limited thereto.

As used herein, the term “functionalized” refers to the presence in a cationic polymer of a plurality of functional groups, other than the cationic groups, which are capable of crosslinking when subjected to heat. Thus, the functional groups are thermally crosslinkable groups. Examples of such functional groups include epoxy, ethylenimino, and episulfido. These functional groups readily react with other groups typically present in the cationic polymer. The other groups typically have at least one reactive hydrogen atom and are exemplified by amino, hydroxy, and thiol groups. It may be noted that the reaction of a functional group with another group often generates still other groups that are capable of reacting with functional groups. For example, the reaction of an epoxy group with an amino group results in the formation of a b-hydroxyamino group.

As used herein, the term “functionalized cationic polymer” is meant to include any polymer that contains a plurality of positively charged groups and a plurality of other functional groups that are capable of being crosslinked by the application of heat. Particularly useful examples of such polymers are epichlorohydrin-functionalized polyamines and epichlorohydrin-functionalized polyamido-amines. Both types of polymers are exemplified by the Kymene® resins which are available from Hercules Inc., Wilmington, Del. Other suitable materials include cationically modified starches, such as RediBond, from National Starch.

As used herein, the term “thermally crosslinked” means heated a polymer, for example, at a temperature and for a time sufficient to crosslink certain groups within the polymer, such as the above-noted functional groups. Heating temperatures may, in some instances, vary from about 50° C. to about 150° C. Heating times can be a function of temperature and the type of functional groups present in the polymer. For example, heating times may vary from less than a minute to about 60 minutes or more. Heating times and temperatures are also determined by the amount of solution in the web that must be evaporated.

As used herein, the term “thermoplastic binder” means any binder, typically a polymer, which is thermoplastic, i.e., capable of softening and flowing when heated and of hardening again when cooled. Examples of thermoplastic binders include, by way of illustration only, end-capped polyacetals, such as poly(oxymethylene) or polyform-aldehyde, poly(tri-chloroacetaldehyde), poly(n-valeraldehyde), poly(acetaldehyde), and poly(propionaldehyde); acrylic polymers, such as polyacrylamide, poly(acrylic acid), poly(methacrylic acid), poly(ethyl acrylate), and poly(methyl methacrylate); fluorocarbon polymers, such as poly(tetrafluoroethylene), perfluorinated ethylene-propylene copolymers, ethylene-tetrafluoroethylene copolymers, poly(chlorotrifluoroethylene), ethylene-chlorotrifluoroethylene copolymers, poly(vinylidene fluoride), and poly(vinyl fluoride); polyamides, such as poly(6-aminocaproic acid) or poly(e-capro-lactam), poly(hexamethylene adipamide), poly(hexamethylene sebacamide), and poly(11-aminoundecanoic acid); polyaramides, such as poly(imino-1,3-phenyleneiminoisophthaloyl) or poly(m-phenylene isophthalamide); parylenes, such as poly-p-xylylene, and poly(chloro-p-xylylene); polyaryl ethers, such as poly(oxy-2,6-dimethyl-1,4-phenylene) or poly(p-phenylene oxide); polyaryl sulfones, such as poly(oxy-1,4-phenylenesulfonyl-1,4-phenyleneoxy-1,4-phenyleneisopropylidene-1,4-phenylene),and poly(sulfonyl-1,4-phenylene-oxy-1,4-phenylenesulfonyl-4,4′-biphenylene);polycarbonates, such as poly(bisphenol A) or poly(carbonyldioxy-1,4-phenyleneisopropylidene-1,4-phenylene); polyesters, such as poly(ethylene terephthalate), poly(tetramethylene tere-phthalate), and poly(cyclohexyl-ene-1,4-dimethylene terephthalate) or poly(oxymethylene-1,4-cyclohexylenemethyleneoxyterephthaloyl); polyaryl sulfides, such as poly(p-phenylene sulfide) or poly(thio-1,4-phenylene); polyimides, such as poly(pyromellitimido-1,4-phenylene); polyolefins, such as polyethylene, polypropylene, poly(1-butene), poly(2-butene), poly(1pentene), poly(2-pentene), poly(3-methyl-1-pentene), and poly(4-methyl-1-pentene); vinyl polymers, such as poly(vinyl acetate), poly(vinylidene chloride), and poly(vinyl chloride); diene polymers, such as 1,2-poly-1,3-butadiene, 1,4-poly-1,3-butadiene, polyisoprene, and polychloroprene; polystyrenes; and copolymers of the foregoing, such as acrylonitrile-butadiene-styrene (ABS) copolymers.

As used herein, any given range is intended to include any and all lesser included ranges. For example, a range of from 45-90 would also include 50-90; 45-80; 46-89; and the like.

### Detailed Description

In general, the present invention relates to an apparatus for filtering a liquid to remove various contaminants. A multi-component filter of the present invention can include a filter element having a generally non-planar surface. The filter may also include a filter element having a generally planar surface.

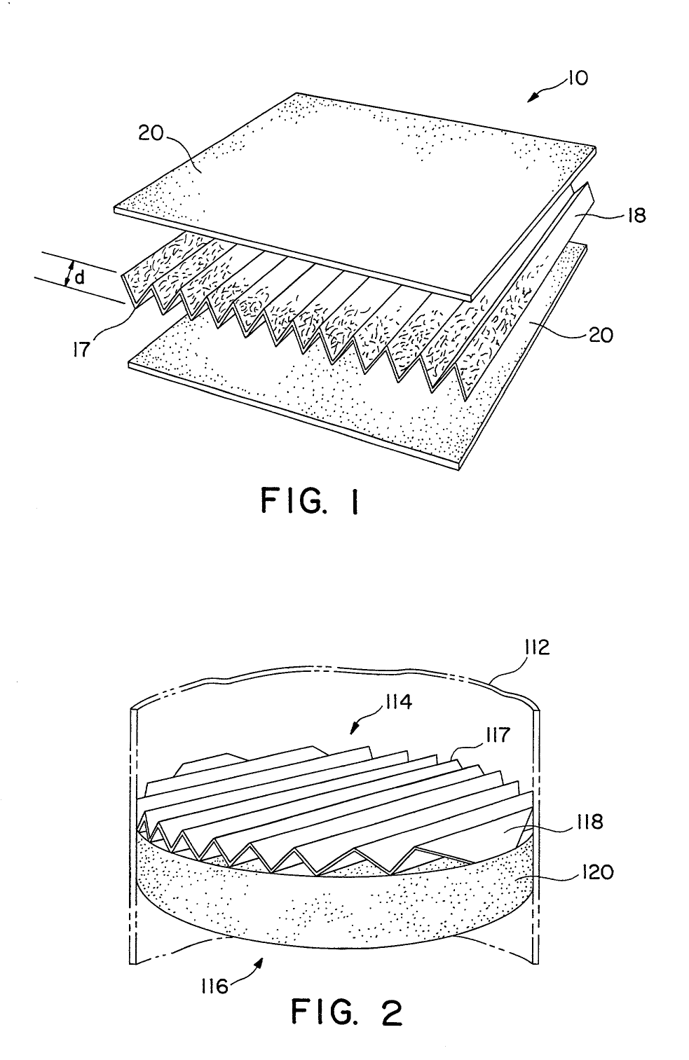

Referring to FIG. 1, for example, one embodiment of the present invention includes a multi-component filter 10 comprising a non-planar filter element 18 having pleats 17. By containing a generally non-planar surface, such as pleats 17, the effective surface contact area of the filter element exposed to fluid flow is increased. Typically, such an increase in surface contact area increases the filtration capabilities of the element. For example, a flat planar filter element 20 having the same thickness has a decreased surface contact area as compared to filter element 18.

A generally non-planar surface of a filter element can be formed from a filter media or material according to any method known in the art for altering the surface characteristics of a material. Such methods may include creping, crumpling, gathering, pleating, molding, etc. Any method for increasing the surface area of a flat or smooth material by changing the surface contour is within the scope and spirit of the present invention. For example, when utilized, pleats 17 of any pattern or size can be imparted to a relatively flat filter element according to a variety of well-known methods. For instance, a “blade pleater” utilizes a blade-like device to fold and advance a material until a desired number of pleats are formed. Moreover, a “rotary pleater” utilizes gears to impart pleats to the surface of a material. As stated above, it should also be understood that the present invention is not limited to pleats, and that any other generally non-planar surface can be utilized.

In addition, a generally non-planar surface of the present invention can also have any of a variety of shapes and sizes. For example, when utilized, pleats can typically have an average pitch (peak-to-peak distance) ranging from about 0.0625 inches to about 5 inches (about 1.5875 mm to about 127 mm). In some embodiments, an average pitch from about 0.125 to about 1 inch (about 3.175 mm to about 25.4 mm) is suitable. In one embodiment, pleats 17 can have an average pitch of about 1 inch (25.4 mm). Moreover, the angle of the pleats can also vary as desired.

In some embodiments of the present invention, the generally non-planar surface can have a surface contact area that is at least about 10% greater than the surface contact area of at least one other filter element, such as a flat filter element, so that an adequate differential surface contact area is provided. In some embodiments, the generally non-planar filter element can have a surface contact area that is about 15% to about 600% or more greater than the surface contact area of at least one other filter element. For instance, referring to FIG. 1, a flat filter element 20 may have a surface contact area of about 12 square inches, in contrast to pleated filter element 18 which may have a surface contact area of about 72 square inches, i.e. about 600% of the surface contact area of flat filter element 20.

It should be understood that although pleats are depicted and described in detail herein, a generally non-planar surface of the present invention need not be a pleated surface. In fact, any other generally non-planar surface can be utilized in a multi-component filter of the present invention, so long as the surface is capable of having a surface contact area for fluid flow therethrough greater than the surface contact area of at least one other filter element.

In accordance with the present invention, a multi-component filter of the present invention can, in some embodiments, also include a filter element having a generally planar surface. For example, as shown in FIG. 1, the multi-component filter 10 may include a filter element 20 having a generally planar surface, such as a flat surface. It should be appreciated that, for a given thickness, the flow rate of a fluid through the respective filters can also be influenced by the surface areas. Thus, the efficiency of the filters for filtering different types of contaminants may be varied by altering the surface configurations (surface areas) or thickness of the filters as desired.

However, it should be understood that a multi-component filter of the present invention need not comprise a filter element having a generally planar surface. For example, the multi-component filter can comprise a first filter element having a generally non-planar surface and a second filter element also having a generally non-planar surface with a greater surface contact area for fluid flow therethrough than the first filter element. In fact, as long as some surface contact area differential exists between two or more filter elements, a multi-component filter of the present invention can provide improved filtration efficiency. For example, in one embodiment, the first filter element can have fewer pleats than the second filter element. Nevertheless, in some instances, it may be desired to utilize a filter element having a generally planar surface in order to minimize costs.

In general, as stated above, the only limitation on filter elements of the present invention is that one or more of the elements comprise a generally non-planar surface. Otherwise, as stated, the filter elements can have any of a variety of shapes or sizes, and be made from any filter media. For instance, referring to FIG. 1, filter element 18 may have an overall width of about 3 inches (7.62 cm), a length of about 4 inches (10.16 cm), and an overall depth (indicated as “d” in FIG. 1) of about 1 inch (2.54 cm). Moreover, in some embodiments, for example, the total filter element volume may be less than about 6 cubic inches or the filter element may have its greatest length (i.e., the longest side) to thickness ratio of no less than about 45 to 1. In some embodiments, a total filter element volume of less than about 1.0 cubic inches or a length to thickness ratio of no less than about 90 to 1 may be employed.

In accordance with the present invention, one or more of the filter elements can optionally be attached or laminated to other filter element(s). The lamination of the filter elements can be accomplished by any method (i.e., adhesives) known in the art for attaching filter media. It should be understood, however, that the filter elements of the present invention need not be attached or laminated.

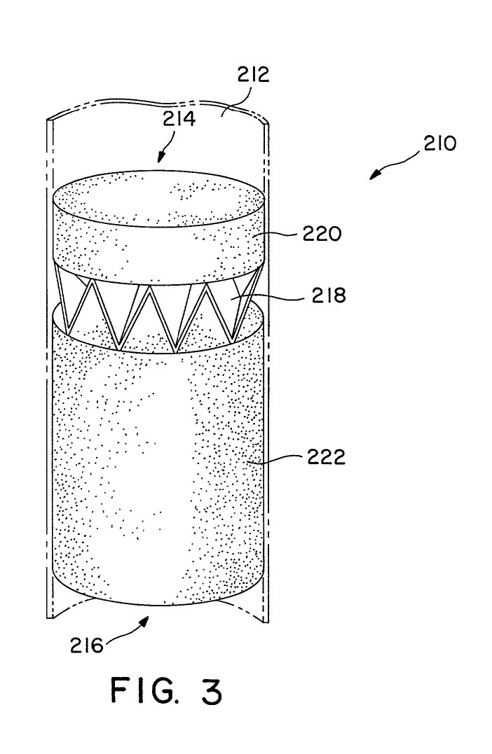

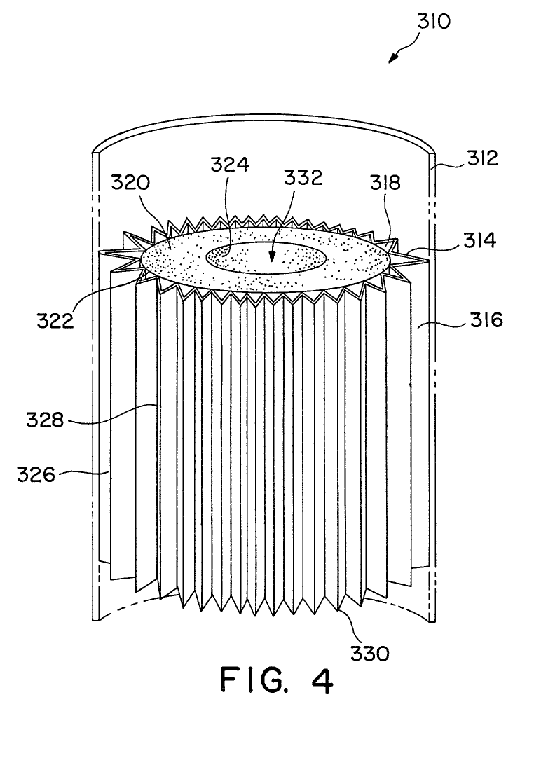

Moreover, in some embodiments, although not required, the filter elements of a multi-component filter of the present invention can be contained within a common filter structure, such as chamber 112 (FIGS. 2-3). If desired, the perimeter of the filter elements can be sealed to chamber 112, although such sealing is not required. The chamber can generally be formed into any shape that accepts the filter elements and allows water to flow therethrough. By way of example only, the chamber may be shaped for various point-of-use applications such as connection to a faucet or insertion into the top of a pitcher. In such applications, the chamber (and thus the filter elements) can be cylindrical. However, the present invention does not require only cylindrical-shaped chambers or filter element(s). For example, square-shaped chambers and/or filter element(s) are equally suitable. Moreover, it is also not required that one filter element have the same shape as another filter elements, nor that the filter element(s) have the same shape as the chamber.

Furthermore, depending on the direction of liquid flow through the multi-component filter, a filter element of the present invention having a generally non-planar surface can have its elevations or depressions in a variety of axial directions to provide a greater surface contact area for the filter element.

For example, referring to FIG. 2, one embodiment of a multi-component filter contained within a chamber is illustrated. As shown, a multi-component water filter 110 includes a chamber 112 having an inlet 114 for water flow; an outlet 116 for water flow; a first filter element 120 within chamber 112 and in fluid communication with outlet 116; and a second filter element 118 within chamber 112 and in fluid communication with inlet 114. The filter elements are in fluid communication, but need not be in contact with each other. Filter element 118 can comprise a material to remove larger-sized contaminants, while filter element 120 can comprise a relatively expensive charge modified media, such as charged microfiber glass, to remove various microorganisms.

In the embodiment shown in FIG. 2, water can pass through chamber 112 in a longitudinal direction with filter elements 118 and 120 disposed transverse to the direction of fluid flow. Pleats 117 of filter element 118 are disposed transverse to the direction of fluid flow so that the surface contact area of filter element 118 to fluid flowing therethrough is increased.

Referring to FIG. 3, a multi-component water filter 210 is depicted that includes a chamber 212 having an inlet 214 for water flow; an outlet 216 for water flow; a first filter element 220 within chamber 212 and in fluid communication with inlet 214; a second filter element 218 within chamber 212; and a third filter element 222 in fluid communication with outlet 216. The first filter element 220 is located within the chamber 212 at a position that allows water to pass through the first filter element 220 prior to passing through the second filter element 218.

The third filter element 222 is located within chamber 212 in a position that allows water to pass through third filter element 222 after passing through the second filter element 218. In another embodiment, the third filter element 222 may also be located in a position that allows water to pass through third filter element 222 first, through second filter element 218 second, and then through first filter element 220. It should be understood, however, that the filter elements of the present invention can be arranged in any desired manner.

The second filter element 218 and third filter element 222 may be constructed of a variety of materials as described above. In some embodiments, the third filter element 222 may include a porous material that exhibits a gradient pore structure, meaning that the diameter of the pores varies from one surface of the filter element to the other surface of the filter element. For example, when the third filter element 222 is intended to act as a sediment-removal stage, the diameter of the pores may decrease from the initial fluid-contact surface to the fluid-outflow surface.

Referring to FIG. 4, another embodiment of the present invention includes a multi-component filter 310 having a chamber 312. A first generally cylindrical filter element 314 and a second generally cylindrical filter element 320 are arranged in the chamber 312 in fluid communication and coaxial and concentric with respect to a longitudinal centerline of the chamber 312. One of the first or second filter elements 314 or 320 is defined by a generally constant radius. In the embodiment of FIG. 4, this filter element is the second cylindrical filter element 320. Filter element 320 has an inner circumferential surface 324 and an outer circumferential surface 322 defined by a generally constant radius therearound. In this manner, the inner and outer circumferential surfaces 324 and 322 define generally continuous planar circumferential filtering surfaces for a liquid passing radially through the filter element.

The filter device 310 includes at least one other filter element having inner and outer circumferential surfaces defined by surface contours. In the embodiment of FIG. 4, this filter element is the first cylindrical filter element 314. Cylindrical filter element 314 has outer circumferential surface 316 and inner circumferential surface 318 defined by a repeating or uniform pattern of elevations 326 and depressions 328. The elevations and depressions may be formed, for example, by pleats 330. In this manner, the inner and outer circumferential surfaces 318 and 316 have a non-constant radius so as to define a generally discontinuous non-planar circumferential filtering surface. This non-planar filtering surface has a greater effective filtering surface area compared to a continuous planar filtering surface having the same overall radius. Thus, filter element 314 presents an increased effective circumferential filtering surface area to a liquid passing radially therethrough.

In the embodiment of FIG. 4, fluid, such as water, flows into chamber 312 and circumferentially around first cylindrical filter element 314. The liquid passes radially through first filter element 314 where contaminants, such as sediment, organics, etc., are removed from the liquid. The liquid then passes radially through second cylindrical filter element 320 wherein a different contaminant is removed from the liquid. The fluid then exits the filter elements through the longitudinal channel 332 defined by second cylindrical filter element 320. It should be understood that the direction of liquid flow may be in either radial direction depending on the arrangement of the cylindrical filter elements. It should also be understood that the multi-component filter according to the invention is not limited to any number or arrangement of filter elements. For example, a plurality of filters corresponding to first cylindrical filter element 314 or second cylindrical filter element 320 may be arranged within chamber 312 in any pattern.

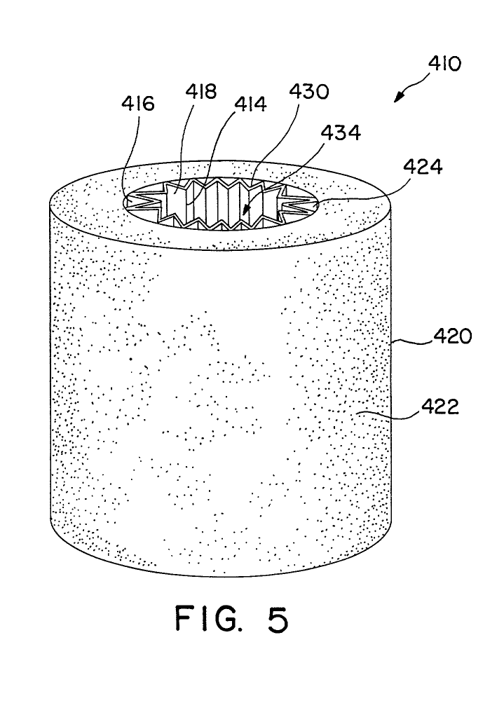

FIG. 5 illustrates an alternative embodiment of the invention wherein the first cylindrical filter element 414 is disposed concentric within the second cylindrical filter element 420. This arrangement may be particularly useful wherein the inner cylindrical filter element requires an increased effective circumferential filtering surface area than would be normally dictated by the radius of the inner circumferential surface 424 of the second cylindrical filter element 420. In this embodiment, liquid may flow into the filter device initially through the inner longitudinal channel 434 defined by first cylindrical filter element 414 and then move radially outward through filter element 414 and filter element 420. The liquid would then flow around the outer circumferential surface 422 of second cylindrical filter element 420 before exiting the filter device 410. Again, an appropriate chamber 412 with the necessary restrictions and flow directing members would be utilized to define the flow paths.

It is to be understood that any other arrangement of the filter elements can be utilized, and that the arrangements depicted and described herein are for illustrative purposes only. For example, the elements may not be present within the same chamber but may be in fluid communication through tubing or the like. Moreover, it should also be appreciated by those skilled in the art that the concentric filters formed according to the present invention can be arranged in any suitable manner within any suitable chamber. Although not illustrated in the Figures, for example, the chamber can use the appropriate deflecting or channeling devices to define an inlet and an outlet for liquid flow through the filter device.

As stated, a filter element of the present invention can generally be made from any type of filter media or material. Typically, the filter media will include various materials used to remove contaminants, turbidity-related components, sediments, organic materials, particulates, microorganisms, and the like, from a liquid. Furthermore, a filter element of the present invention can also contain a laminate, i.e. two or more layers, of filter media where different layers may or may not remove different constituents or may support the filter media. In one embodiment, one or more of the filter elements include an absorbent material, such as cellulosic-based materials. In another embodiment, a nonwoven web of fibrous material can be used, such as meltblown or spunbond webs containing mono- or bi-component fibers. Moreover, in one embodiment, the nonwoven web may be a bonded carded web. In addition, microporous materials, such as nonwoven meltblown webs or nonwoven microfiber glass webs can also be used in the present invention. Further, various charge-modified media, such as nonwoven charge-modified meltblown webs or nonwoven charge-modified microfiber glass webs, can be used as well. Still other examples of a suitable material can include a variety of composite materials, such as air laid composites. Generally, if microporous materials are employed, such materials may have pore sizes that are 20 microns or less in diameter size, and in some embodiments, pore sizes that are 10 microns or less in size. In other embodiments, the microporous materials will have a maximum pore size of 7.5 microns. These include various microfiber glass configurations as well as various nonwoven webs.

In general, when used as a filter media, a charge-modified microfiber glass web can contain at least about 50 percent by weight of glass fibers, based on the weight of all fibers present in the filter media. In some embodiments, essentially 100 percent of the fibers will be glass fibers. When other fibers are present, however, they generally will be cellulosic fibers, fibers prepared from synthetic thermoplastic polymers, or mixtures thereof.

As discussed briefly above, a nonwoven charge-modified meltblown web may contain hydrophobic polymer fibers, amphiphilic macromolecules adsorbed onto at least a portion of the surfaces of the hydrophobic polymer fibers, and a crosslinkable, functionalized cationic polymer associated with at least a portion of the amphiphilic macromolecules, in which the functionalized cationic polymer has been crosslinked. Crosslinking may be achieved through the use of a chemical crosslinking agent or by the application of heat. Desirably, thermal crosslinking, i.e., the application of heat, will be employed. In general, the amphiphilic macromolecules may be of one or more of the following types: proteins, poly(vinyl alcohol), monosaccharides, disaccharides, polysaccharides, polyhydroxy compounds, polyamines, polylactones, and the like. Desirably, the amphiphilic macromolecules will be amphiphilic protein macromolecules, such as globular protein or random coil protein macromolecules. For example, the amphiphilic protein macromolecules may be milk protein macromolecules. The functionalized cationic polymer typically may be any polymer that contains a plurality of positively charged groups and a plurality of other functional groups that are capable of being crosslinked by, for example, chemical crosslinking agents or the application of heat. Particularly useful examples of such polymers are epichlorohydrin-functionalized polyamines and epichlorohydrin-functionalized polyamido-amines. Other suitable materials include cationically modified starches.

The nonwoven charge-modified meltblown web may be prepared by a method which involves providing a fibrous meltblown filter media which includes hydrophobic polymer fibers, passing a solution containing amphiphilic macromolecules through the fibrous filter under shear stress conditions so that at least a portion of the amphiphilic macromolecules are adsorbed onto at least some of the hydrophobic polymer fibers to give an amphiphilic macromolecule-coated fibrous web, passing a solution of a crosslinkable, functionalized cationic polymer through the amphiphilic macromolecule-coated fibrous web under conditions sufficient to incorporate the functionalized cationic polymer onto at least a portion of the amphiphilic macromolecules to give a functionalized cationic polymer-coated fibrous web in which the functionalized cationic polymer is associated with at least a portion of the amphiphilic macromolecules, and treating the resulting coated fibrous filter with a chemical crosslinking agent or heat. Desirably, the coated fibrous filter will be treated with heat at a temperature and for a time sufficient to crosslink the functionalized cationic polymer.

One particular example of a filter element that may be employed in the present invention is a material manufactured by K-X Industries under the name of “PLEKX”. This filter element includes three layers, i.e., a charge modified layer laminated onto both the top and bottom of a layer containing activated carbon. The thickness of the entire laminate is approximately 0.050 of an inch. By way of example only, in one embodiment of the invention, the surface area of one side of a circularly shaped, flat “PLEKX” filter may be about 20 square inches, resulting in a diameter of about 5 inches. This example would have a filter media volume of about 1 cubic inch and a greatest length to thickness ratio of about 100 to 1.

In addition, various other materials can be utilized in a filter layer of the present invention. For instance, in one embodiment, one or more of the filter layers can comprise activated carbon. Activated carbon may be present in granular form, or compressed into a volume having any of a myriad of shapes, including cylinders, sheets, and discs. Solid porous filter shapes are especially desirable for ease of handling and ready disposability. These may be manufactured by extruding a mixture of a thermoplastic binder material and a powdered or granular form of activated carbon. Various other components may be present in this activated carbon-containing stage, such as zeolites, ion-exchange resins, binder agents, and various other adsorbents.

It should be understood that the materials listed above represent only some examples of suitable filtration materials that can be used in the present invention. In particular, any other filtration material or material capable of possessing at least some filtering properties can be utilized in the present invention. It should also be understood that various combinations of the materials listed above, as well as other materials, can be used to form one or more filter elements of the present invention. Moreover, the basis weights, geometries, and other characteristics of the filter elements can be varied as well.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A multi-component liquid filter, comprising:
a first filter element defining a surface having a finite surface contact area, said first filter element being configured to selectively remove a first contaminant from a liquid when contacted therewith; and
a second filter element disposed in fluid communication with said first filter element, said second filter element having a generally non-planar surface, said generally non-planar surface having a surface contact area greater than said surface contact area of said first filter element, said second filter element being configured to selectively remove a second contaminant from a liquid when contacted therewith.

2. A multi-component liquid filter as defined in claim 1, wherein said surface of said first filter element is a generally planar surface.

3. A multi-component liquid filter as defined in claim 1, wherein said generally non-planar surface is a pleated surface.

4. A multi-component liquid filter as defined in claim 3, wherein said pleated surface comprises pleats having an average pitch from about 0.0625 to about 5 inches.

5. A multi-component liquid filter as defined in claim 3, wherein said pleated surface comprises pleats having an average pitch from about 0.125 to about 1 inch.

6. A multi-component liquid filter as defined in claim 3, wherein said pleated surface comprises pleats disposed longitudinally in a direction transverse to fluid flow through said second filter element.

7. A multi-component liquid filter as defined in claim 1, wherein both of said filter elements are contained with a chamber.

8. A multi-component liquid filter as defined in claim 7, wherein said first and said second filter elements are generally cylindrical, said generally cylindrical filter elements being arranged

9. A multi-component liquid filter as defined in claim 8, wherein one of said first and second filter elements has inner and outer circumferential surfaces defined by a generally constant radius therearound so as to define generally continuous planar circumferential filtering surfaces for a liquid passing radially through said filter element, the other of said respective filter elements having inner and outer circumferential surfaces defined by surface contours such that said circumferential surfaces have a non-constant radius therearound so as to define a generally discontinuous non-planar circumferential filtering surface with a greater effective filtering surface area compared to a continuous planar filtering surface for a liquid passing radially through said other filter element, wherein liquid flows radially through said filter elements within said chamber such that different contaminants are removed by said respective filter elements prior to the liquid flowing from said chamber.

10. A multi-component liquid filter as defined in claim 9, wherein said filter element with said constant radius circumferential surfaces is disposed concentric within said other filter element having said surface contours.

11. A multi-component liquid filter as defined in claim 9, wherein said other filter element with said surface contours is disposed concentric within said filter element with said constant radius circumferential surfaces.

12. A multi-component liquid filter as defined in claim 1, wherein at least one of said filter elements comprises a material selected from the group consisting of microfiber glass, a charge-modified material, a nonwoven web, a bed of granular material, a cellulosic material, a particulate laminate, activated carbon, airlaid composites, and combinations thereof.

13. A multi-component liquid filter as defined in claim 1, wherein at least one of said filter elements comprises a particulate laminate having a layer containing activated carbon laminated to at least one other layer containing a nonwoven web.

14. A multi-component liquid filter as defined in claim 1, wherein said surface contact area of said second filter element is at least about 10% greater than said surface contact area of said first filter element.

15. A multi-component liquid filter as defined in claim 1, wherein said surface contact area of said second filter element is about 15% to about 600% greater than said surface contact area of said first filter element.

16. A multi-component liquid filter, comprising:
a first filter element having a generally planar surface, said generally planar surface having a certain surface contact area, said first filter element comprising a material configured to selectively remove a first contaminant;
a second filter element disposed adjacent to said first filter layer, said second filter element comprising a material that is configured to selectively remove a second contaminant selected from the group consisting of turbidity-related components, sediment, organic materials, particulates, microorganisms, and combinations thereof; and
said second filter element having a pleated surface, said pleated surface having a surface contact area at least about 10% greater than said surface contact area of said generally planar surface of said first filter element.

17. A multi-component liquid filter as defined in claim 16, wherein said surface contact area of said second filter element is between about 15% to about 600% greater than said surface contact area of said first filter element.

18. A multi-component liquid filter as defined in claim 16, wherein said pleated surface comprises pleats having an average pitch from about 0.0625 to about 5 inches.

19. A multi-component liquid filter as defined in claim 16, wherein said pleated surface comprises pleats having an average pitch from about 0.125 to about 1 inch.

20. A multi-component liquid filter as defined in claim 16, wherein at least one of said filter elements comprises a material selected from the group consisting of microfiber glass, a charge-modified material, a nonwoven web, a bed of granular material, a cellulosic material, a particulate laminate, activated carbon, airlaid composites, and combinations thereof.

21. A multi-component liquid filter as defined in 16, wherein both of said filter elements are contained within a chamber.

22. A multi-component liquid filter as defined in claim 21, wherein said first and said second filter elements are generally cylindrical, wherein said generally cylindrical filter elements are arranged in fluid communication within said chamber coaxial with respect to a longitudinal centerline of said chamber.

23. A multi-component liquid filter device, comprising:
a chamber;
a first generally cylindrical filter element, and a second generally cylindrical filter element, said filter elements arranged in fluid communication within said chamber coaxial with respect to a longitudinal centerline of said chamber;
one of said first and second filter elements having inner and outer circumferential surfaces defined by a generally constant radius therearound so as to define generally continuous planar circumferential filtering surfaces for a liquid passing radially through said filter element;
the other of said respective filter elements having inner and outer circumferential surfaces defined by surface contours such that said circumferential surfaces have a non-constant radius therearound so as to define a generally discontinuous non-planar circumferential filtering surface with a greater effective filtering surface area compared to a continuous planar filtering surface for a liquid passing radially through said other filter element; and
wherein liquid flows radially through said filter elements within said chamber such that different contaminants are removed by said respective filter elements prior to the liquid flowing from said chamber.

24. A filter device as defined in claim 23, wherein said surface contours of said other filter element comprise surface elevations and depressions.

25. A filter device as defined in claim 24, wherein said elevations and depressions are in a uniform repeating pattern.

26. A filter device as defined in claim 24, wherein said elevations and depressions comprise pleats.

27. A filter device as defined in claim 26, wherein said pleats have an average pitch from about 0.0625 inches to about 5.0 inches.

28. A filter device as defined in claim 26, wherein said pleats have an average pitch from about 0.125 inches to about 1.0 inch.

29. A filter device as defined in claim 23, wherein said filter element with said constant radius circumferential surfaces is disposed concentric within said other filter element having said surface contours.

30. A filter device as defined in claim 23, wherein said other filter element with said surface contours is disposed concentric within said filter element with said constant radius circumferential surfaces.

31. A filter device as defined in claim 23, wherein at least one of said filter elements comprises a material selected from the group consisting of microfiber glass, a charge-modified material, a nonwoven web, a bed of granular material, a cellulosic material, a particulate laminate, activated carbon, airlaid composites, and combinations thereof.

32. A filter device as defined in claim 23, wherein at least one of said filter elements comprises a particulate laminate having a layer containing activated carbon laminated to at least one other layer containing a nonwoven web.
